(19) United States
(12) Patent Application Publication
(10) Pub. No.: US 2025/0130380 A1
(43) Pub. Date: Apr. 24, 2025

(54) OPTICAL DEVICES AND METHODS OF MANUFACTURE

(71) Applicant: Taiwan Semiconductor Manufacturing Co., Ltd., Hsinchu (TW)

(72) Inventors: Chen-Hua Yu, Hsinchu (TW); Hsing-Kuo Hsia, Jhubei City (TW); Chih-Wei Tseng, Hsinchu (TW); Jiun Yi Wu, Zhongli City (TW); Jui Lin Chao, New Taipei City (TW)

(21) Appl. No.: 18/431,117

(22) Filed: Feb. 2, 2024

Related U.S. Application Data
(60) Provisional application No. 63/592,246, filed on Oct. 23, 2023.

(51) Int. Cl. G02B 6/42

(52) U.S. Cl. CPC G02B 6/4239; G02B 6/4214

(57) ABSTRACT

Optical devices and methods of manufacture are presented in which glass interposers are incorporated with optical devices. In some embodiments a method includes forming a first optical package and then bonding the first optical package to a first glass interposer. The first glass interposer may then be connected to a second interposer.

### PRIORITY CLAIM AND CROSS-REFERENCE

This application claims the benefit of U.S. Provisional Application No. 63/592,246, filed on Oct. 23, 2023, entitled “Package Structure,” which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIG. 11 illustrates bonding of the first optical package to a glass interposer, in accordance with some embodiments.

FIG. 12 illustrates an attachment of a fiber array unit assembly to the first optical package, in accordance with some embodiments.

FIG. 13 illustrates optical paths for optical signals, in accordance with some embodiments.

FIGS. 14A-14B illustrate usage of external connectors, in accordance with some embodiments.

FIG. 15 illustrates optical paths for optical signal with the external connectors, in accordance with some embodiments.

FIG. 16 illustrates incorporation of a second substrate with glass, in accordance with some embodiments.

FIG. 17 illustrates optical paths for optical signal with the second substrate, in accordance with some embodiments.

FIGS. 18A-18B illustrate a multiple module structure with the second substrate, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a glass interposer is utilized to interconnect a compact universal photonic engine (COUPE). However, the embodiments presented herein are intended to be illustrative and are not intended to limit the embodiments to the precise descriptions as discussed. Rather, the embodiments discussed may be incorporated into a wide variety of implementations, such as silicon photonics in general, or 3-D ICs with photonic applications, and all such implementations are fully intended to be included within the scope of the embodiments.

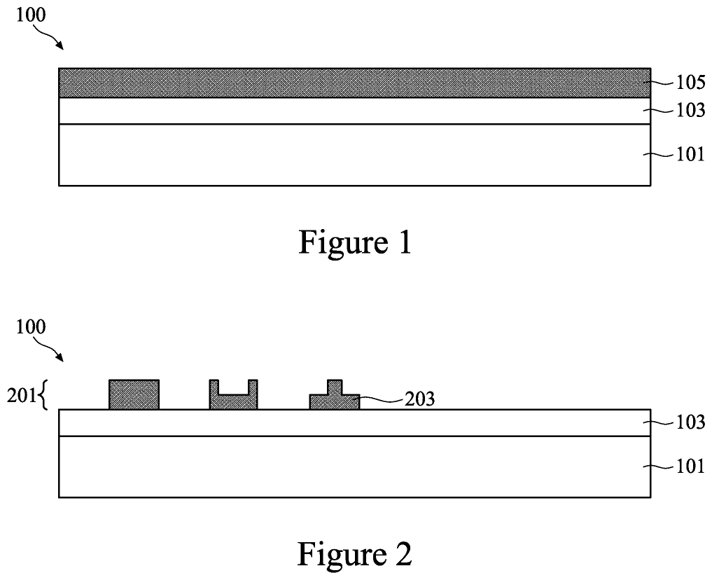

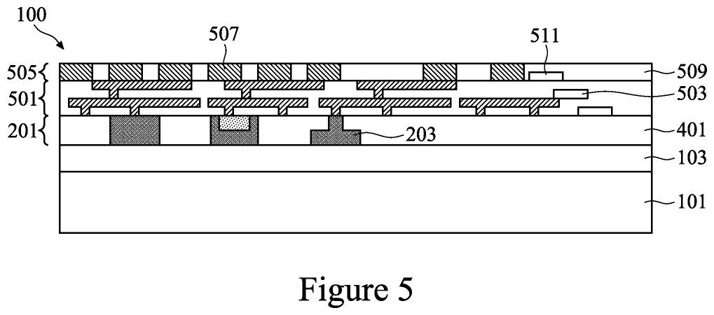

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

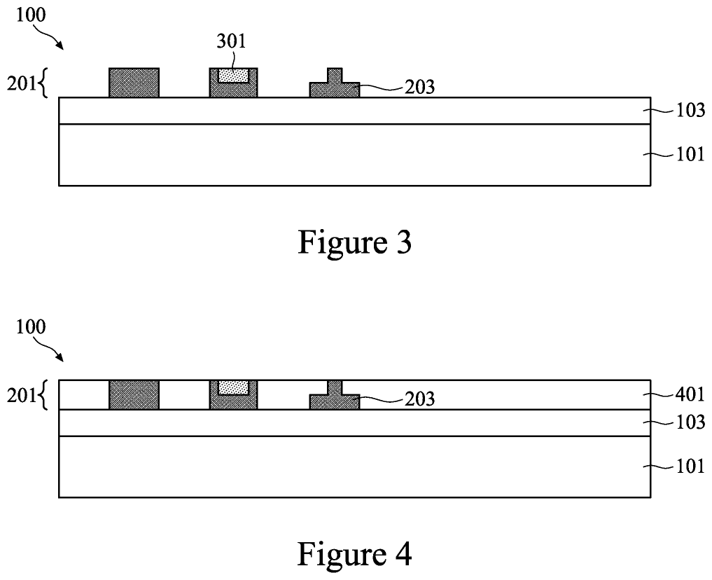

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

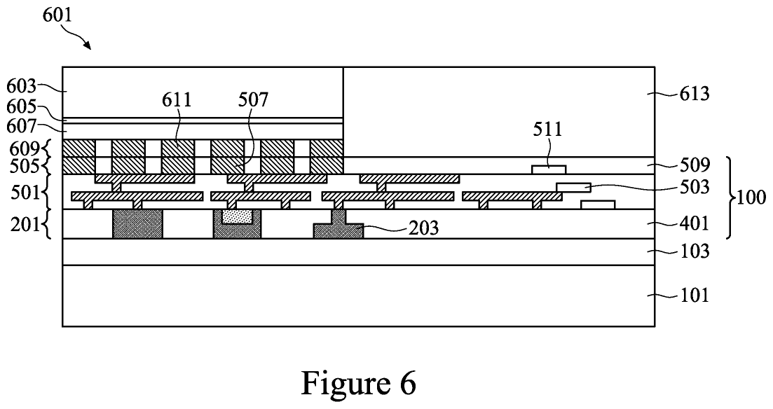

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated second bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the second bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the second bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a gap-fill material 613 is deposited in order to fill the space around the first semiconductor device 601 and provide additional support. In an embodiment the gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the second gap-fill material 613 has been deposited, the gap-fill material 613 may be planarized in order to expose the first semiconductor device 601. In an embodiment the planarization process may be a chemical mechanical planarization process, a grinding process, or the like. However, any suitable planarization process may be utilized.

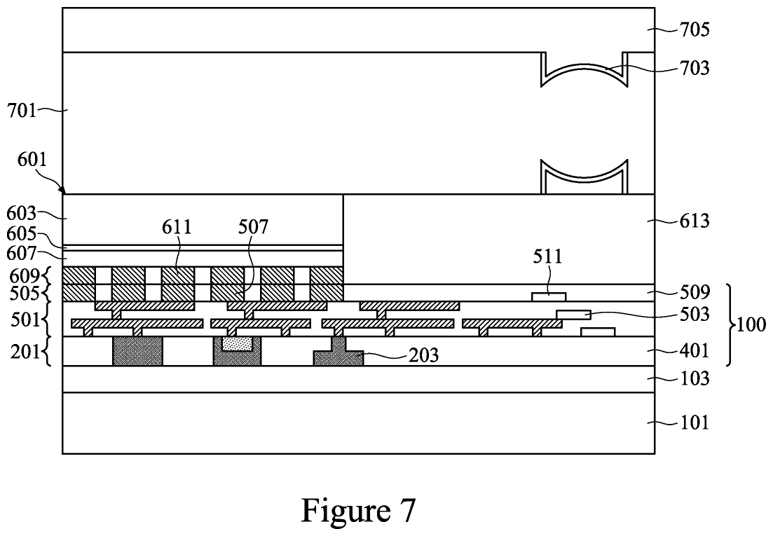

FIG. 7 illustrates an attachment of a support substrate 701 to the first semiconductor device 601 and the gap-fill material 613. In an embodiment the support substrate 701 may be a support material that is transparent to the wavelength of light that is desired to be used, such as silicon, and may be attached using, e.g., an adhesive (not separately illustrated in FIG. 7). However, in other embodiments the support substrate 701 may be bonded to the first semiconductor device 601 and the gap-fill material 613 using, e.g., a bonding process. Any suitable method of attaching the support substrate 701 may be used.

FIG. 7 additionally illustrates the support substrate 701 comprises coupling lenses 703 positioned to facilitate movement from an optical fiber (not illustrated in FIG. 7) to the optical interposer 100. In an embodiment the coupling lenses 703 may be formed by shaping the material of the support substrate (e.g., silicon) using masking and etching processes. However, any suitable process may be utilized.

FIG. 7 also illustrates formation of an oxide layer 705 over the support substrate 701. In an embodiment the oxide layer 705 may be formed using similar processes and materials as the gap-fill material 613 (described above with respect to FIG. 6). However, any suitable methods and materials may be utilized.

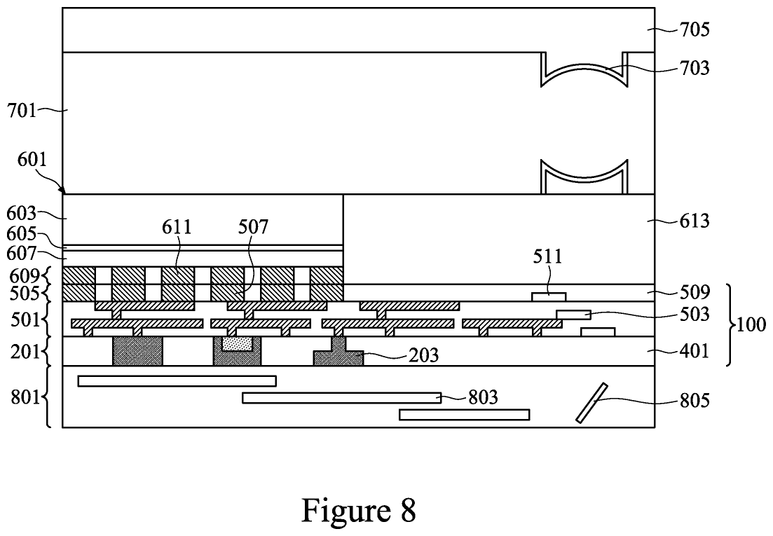

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

FIG. 8 additionally illustrates that a first mirror 805 may be formed within the second active layer 801. In an embodiment the first mirror 805 may be formed by initially forming a recess (not separately illustrated in FIG. 8) using, e.g., a photolithographic masking and etching process. Once the recess has been formed, a mirror coating may be deposited to line the recess. In an embodiment the mirror coating may be a single layer of a reflective material such as aluminum copper, copper, gold, aluminum, combinations of these, or the like, or else may be a multi-layer structure such as a Bragg's reflector comprising alternating layers of silicon dioxide and amorphous silicon. The individual materials of the mirror coating may be deposited using any suitable methods, such as chemical vapor deposition, physical vapor deposition, plating, combinations of these, or the like, and the individual layers may be then be further patterned using, e.g., a photolithographic masking and etching process (for example, to remove horizontal portions of the deposited materials). The material for the mirror coating may be deposited to a thickness of between about 500 Å and about 3000 Å. However, any suitable materials and methods may be utilized in order to form the mirror coating along the sidewalls of the recess.

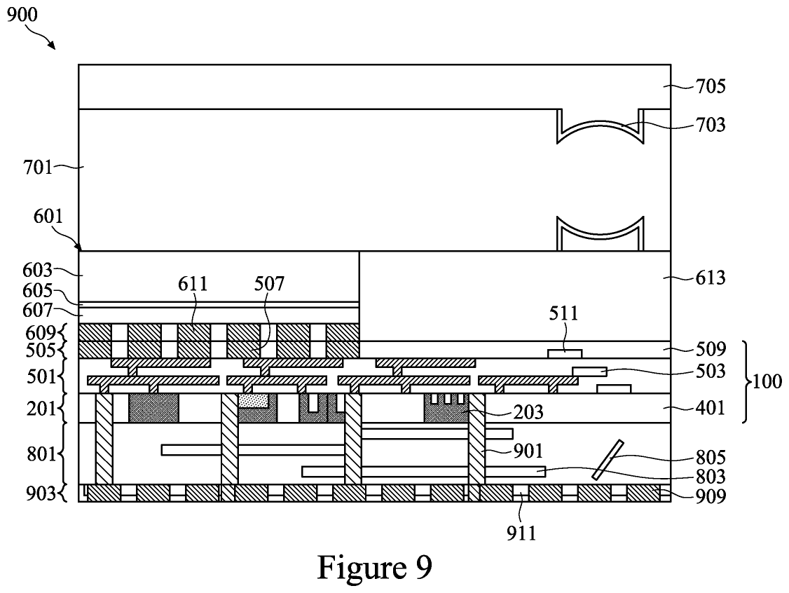

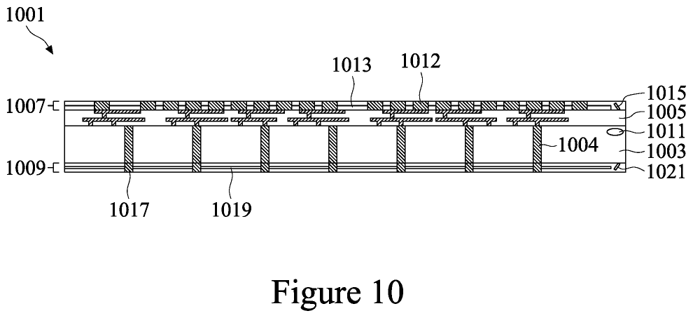

FIG. 9 illustrates formation of first through device vias (TDVs) 901, formation of a third bonding layer 903. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

FIG. 10 illustrates a glass interposer 1001 to which the first optical package 900 will be connected. In an embodiment the glass interposer 1001 comprises a second substrate 1003, second through device vias 1004, a third metallization layer 1005, a fourth bonding layer 1007, and a fifth bonding layer 1009. Looking first at the second substrate 1003, the second substrate 1003 may comprise a material that allows for visual transparency with high dimensional stability under thermal loads, and still has a coefficient of thermal expansion which is close to the silicon found in other parts of the device. In particular embodiments the second substrate 1003 may be formed of a material such as glass, polymer, epoxy, combinations of these, or the like. However, any suitable material may be utilized.

A first lens 1011 may be formed within the second substrate 1003 in order to help connect both sides by re-collimating optical signals as the optical signals pass through the first lens 1011. In an embodiment the first lens 1011 may be formed using a laser ablation process, a masking and etching process, combinations of these, or the like. In embodiments in which the second substrate 1003 is glass, a laser ablation process may be used in order to form holographic patterns within the glass of the second substrate 1003. However, any suitable process may be utilized.

Of course, while the first lens 1011 is described as being formed using the laser ablation process, this is not the only device that may be formed using the laser ablation process. For example, waveguides, other lenses, and other optical components could be similarly formed. All such devices and all suitable methods for forming those devices are fully intended to be included within the scope of the embodiments.

The second through device vias 1004 may be formed to extend through the second substrate 1003 and provide an electrical connection between a first side of the second substrate 1003 to a second side of the second substrate 1003. In an embodiment the second through device vias 1004 may be formed using similar processes and similar materials as the first through device vias 901, such as forming an opening, depositing conductive material within the opening, and then thinning to expose the conductive material, described above with respect to FIG. 9. However, any suitable methods and materials may be utilized.

The third metallization layer 1005 may be formed over a first side of the second substrate 1003. In an embodiment the third metallization layer 1005 may be formed as described above with respect to the first metallization layers 501, such as being alternating layers of dielectric and conductive materials using damascene processes, dual damascene process, or the like. In other embodiments, the third metallization layer 1005 may be formed using a plating process to form and shape conductive material, and then cover the conductive material with a dielectric material. However, any suitable structures and methods of manufacture may be utilized.

The fourth bonding layer 1007 is formed in order to provide electrical connections between the glass interposer 1001 and subsequently attached devices. In an embodiment the fourth bonding layer 1007 may be similar to the first bonding layer 505, such as having fourth bond pads 1012 (similar to the first bond pads 507) and even sixth optical components 1013 (similar to the third optical components 511). However, any suitable devices may be utilized.

The fourth bonding layer 1007 may additionally comprise a second mirror 1015. In an embodiment the second mirror 1015 may be formed by initially forming a recess (not separately illustrated in FIG. 10) using, e.g., a photolithographic masking and etching process. Once the recess has been formed, a mirror coating may be deposited to line the recess. In an embodiment the mirror coating may be a single layer of a reflective material such as aluminum copper, copper, gold, aluminum, combinations of these, or the like, or else may be a multi-layer structure such as a Bragg's reflector comprising alternating layers of silicon dioxide and amorphous silicon. The individual materials of the mirror coating may be deposited using any suitable methods, such as chemical vapor deposition, physical vapor deposition, plating, combinations of these, or the like, and the individual layers may be then be further patterned using, e.g., a photolithographic masking and etching process (for example, to remove horizontal portions of the deposited materials). The material for the mirror coating may be deposited to a thickness of between about 500 Å and about 3000 Å. However, any suitable materials and methods may be utilized in order to form the mirror coating along the sidewalls of the recess.

Looking next at the fifth bonding layer 1009, the fifth bonding layer 1009 may be similar to the first bonding layer 505, such as having fifth bond pads 1017 (similar to the first bond pads 507) and even seventh optical components 1019 (similar to the third optical components 511). However, any suitable devices and methods may be utilized.

Additionally, the fifth bonding layer 1009 may further comprise a third mirror 1021. In an embodiment the third mirror 1021 may be formed using similar methods and materials as the second mirror 1015. However, any suitable methods may be utilized.

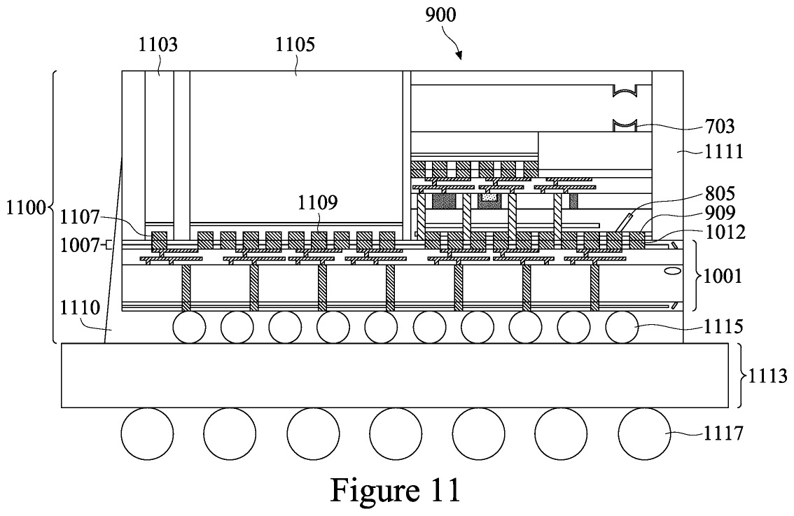

FIG. 11 illustrates that, once the glass substrate 1001 has been formed, the first optical package 900 may be attached to the glass interposer 1001. In an embodiment the first optical package 900 may be attached to the glass interposer 1001 using a dielectric-to-dielectric and metal-to-metal bonding process, similar to the process described above with respect to FIG. 6. For example, surfaces of the first optical package 900 and the glass interposer 1001 are activated, the third bond pads 909 are aligned and placed in contact with the fourth bond pads 1012, and the bonds are strengthened using subsequent annealing and pressure. However, any suitable bonding process may be utilized.

FIG. 11 additionally illustrates a bonding of a laser die 1103 and a second semiconductor device 1105 to the glass interposer 1001. In an embodiment, the laser die 1103 is additionally bonded to the glass interposer 1001 to provide a power source for the optical devices instead of the glass interposer 1001 receiving light from outside. In some embodiments, the laser die 1103 may comprise light generating structures such as one or more laser diodes (not separately illustrated in FIG. 11) surrounded by dielectric and/or cladding material over a substrate. In particular embodiments the laser diodes may be Fabry-Perot Diodes, and may be based on III-V materials, II-VI materials, or any other suitable set of materials.

In a particular embodiment the one or more laser diodes may comprise a first contact, a first buffer layer, a first active diode layer comprising multiple quantum wells (MQWs), a second buffer layer, and a second contact (not separately illustrated in FIG. 11) in order to generate the desired light. Additionally, the generated light may be output from the laser die 1103 through, e.g., the first contact and associated waveguides. However, any suitable structures may be utilized in order to form the one or more laser diodes and generate the desired light.

Additionally, the laser die 1103 may also comprise sixth bond pads 1107. In an embodiment the sixth bond pads 1107 may be similar to the third bond pads 909, such as by being contact pads. However, any suitable materials and shape of connections may also be utilized.

Once the laser die 1103 has been formed and/or otherwise received, the laser die 1103 may be bonded to the glass interposer 1001. In an embodiment the laser die 1103 may be bonded to the glass interposer 1001 using a dielectric-to-dielectric and metal-to-metal, similar to the bonding process described above with respect to FIG. 6. However, any suitable bonding process may be utilized.

FIG. 11 additionally illustrates a bonding of a second semiconductor device 1105 onto the glass interposer 1001. In some embodiments, the second semiconductor device 1105 is an electronic integrated circuit (EIC) such as a stacked device that includes multiple, interconnected semiconductor substrates. For example, the second semiconductor device 1105 may be an ASIC device, a memory device such as a high bandwidth memory (HBM) module, a hybrid memory cube (HMC) module, xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the second semiconductor device 1105 may be bonded to the glass interposer 1001 using, e.g., seventh bond pads 1109. In an embodiment the seventh bond pads 1109 may be similar to the third bond pads 909, such as by being contact pads. However, any suitable materials and shape of connections may also be utilized.

Additionally, once the seventh bond pads 1109 have been formed, the second semiconductor device 1105 is bonded with the glass interposer 1001. In an embodiment the second semiconductor device 1105 may be bonded to the glass interposer 1001 using a dielectric-to-dielectric and metal-to-metal, similar to the bonding process described above with respect to FIG. 11. However, any suitable bonding process may be utilized.

Once the second semiconductor device 1105 has been bonded, the second semiconductor device 1105, the laser die 1103, and the first optical package 900 are encapsulated with an encapsulant 1111 to form a first module 1100. In an embodiment, the encapsulant 1111 may be a molding compound, epoxy, or the like. The encapsulant 1111 may be applied by compression molding, transfer molding, or the like. The encapsulant 1111 is further placed in gap regions between the second semiconductor device 1105, the laser die 1103, and the first optical package 900. The encapsulant 1111 may be applied in liquid or semi-liquid form and then subsequently cured.

A planarization process is performed on the encapsulant 1111 once the encapsulant 1111 has been placed. Once planarized, top surfaces of the encapsulant 1111, the second semiconductor device 1105, the laser die 1103, and the first optical package 900 are substantially coplanar after the planarization process within process variations. The planarization process may be, for example, a chemical-mechanical polish (CMP), a grinding process, or the like. In some embodiments, the planarization may be omitted.

Once the second semiconductor device 1105, the laser die 1103, and the first optical package 900 have been bonded to the glass interposer 1001, the glass interposer 1001 may be bonded to a second substrate 1113 with, e.g., first external connectors 1115. In an embodiment the second substrate 1113 may be a package substrate, which may be a printed circuit board (PCB) or the like. The second substrate 1113 may include one or more dielectric layers and electrically conductive features, such as conductive lines and vias. In some embodiments, the second substrate 1113 may include through-vias, active devices, passive devices, and the like. The second substrate 1113 may further include conductive pads formed at the upper and lower surfaces of the second substrate 1113.

The first external connectors 1115 may be aligned with corresponding conductive connections on the second substrate 1113. Once aligned the first external connectors 1115 may then be reflowed in order to bond the second substrate 1113 to the glass interposer 1001. However, any suitable bonding process may be used to connect the glass interposer 1001 to the second substrate 1113.

Once bonded, a first underfill 1110 may be placed around the first external connectors 1115. In an embodiment the first underfill 1110 is a protective material used to cushion and support the structure from operational and environmental degradation, such as stresses caused by the generation of heat during operation. The first underfill 1110 may be placed using an injection process with capillary action or may be otherwise formed, and the first underfill 1110 may, for example, comprise a liquid epoxy that is dispensed then cured to harden.

Additionally, the second substrate 1113 may be prepared for further by placing by forming second external connectors 1117 on an opposite side of the second substrate 1113 from the first optical package 900. In an embodiment the second external connectors 1117 may be formed using similar processes and materials as the first external connectors 1115. However, any suitable materials and processes may be utilized.

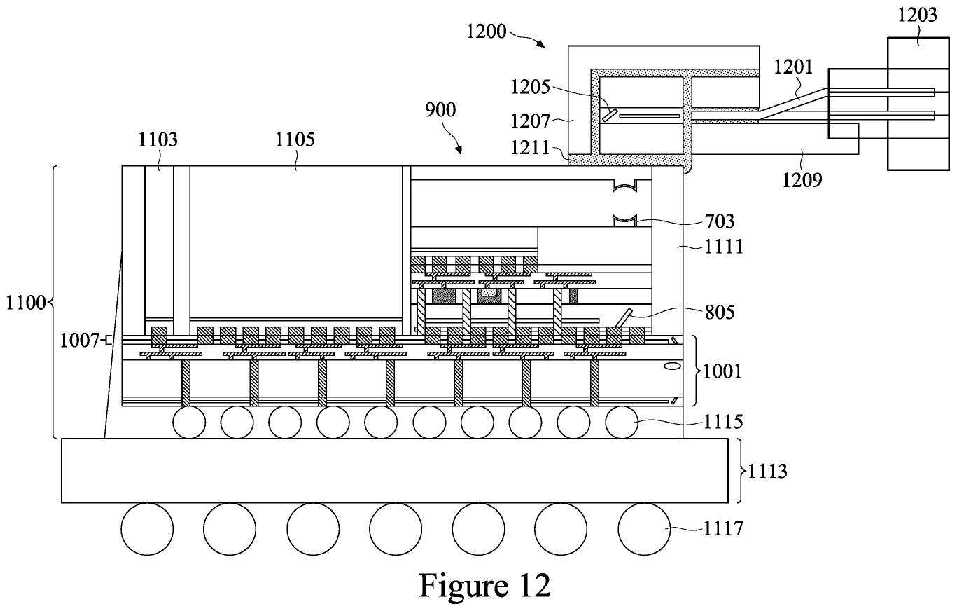

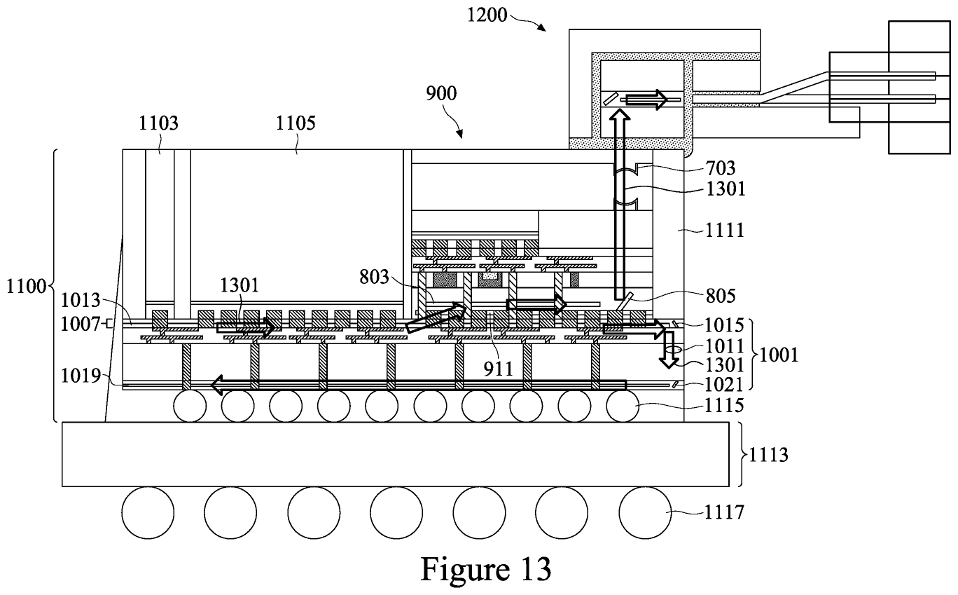

FIG. 12 illustrates an attachment of a fiber array unit (FAU) assembly 1200 to provide an ingress and egress to optical signals 1301 (not illustrated in FIG. 13 but illustrated and described further below with respect to FIG. 13). In an embodiment the fiber array unit assembly 1200 receives optical fibers 1201, arranges the optical fibers 1201 with a fiber sheath 1203, and directs the optical signals towards a deflection mirror 1205 aligned with the coupling lenses 703. Support materials such as glass portions 1207 and a silicon substrate 1209 support the deflection mirror 1205 and optical fibers 1201 and are held together with an index matching gel 1211.

FIG. 13 illustrates a plurality of optical paths that the optical signals 1301 (represented by the arrows labeled 1301) may be taken through the various structures. In one path, the optical signals 1301 may be created by the laser die 1103 and evanescently coupled to the sixth optical components 1013 within the fourth bonding layer 1007. The fourth bonding layer 1007 routes the optical signals 1301 to the first optical package 900, wherein the optical signals 1301 are evanescently coupled into the fifth optical components 911 of the third bonding layer 903 and the fourth optical components 803 of the second active layer 801. From the fifth optical components 911 and the fourth optical components 803, the optical signals 1301 may be directed towards the first mirror 805, which redirects the optical signals 1301 through the coupling lenses 703 and into the fiber array unit assembly 1200.

Looking at another optical path that may be taken through the structure, the optical signals 1301 may be created by the laser die 1103 and evanescently coupled to the sixth optical components 1013 within the fourth bonding layer 1007. The fourth bonding layer 1007 routes the optical signals 1301 to the second mirror 1015, which redirects the optical signals 1301 through the first lens 1011 to the third mirror 1021. The third mirror 1021 then redirects the optical signals 1301 into the seventh optical components 1019.

By utilizing the glass interposer 1101 as described above, there is an increase in the dimensional stability of the device under thermal load. In particular, by using materials with a similar coefficient of thermal expansion as the other structures (e.g., glass), there is less overall stress related when under a thermal load. Additionally, by using glass there are alignment benefits as a result of visual transparency, which helps to discern the via hole positions more easily, allowing for a narrower pad layout (whereas previous mis-alignments used a wider pad layout). This allows for a dense juxtaposition of devices.

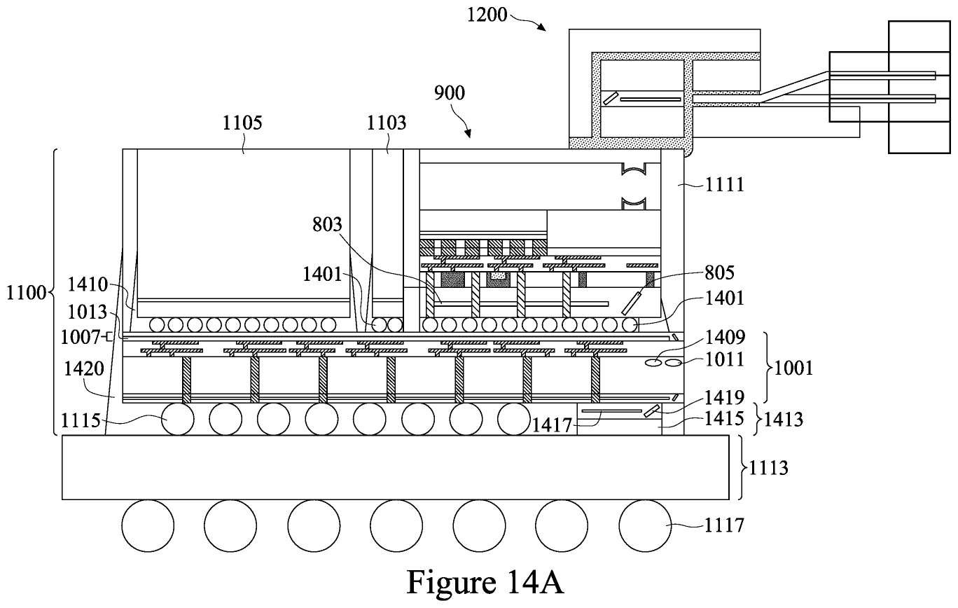

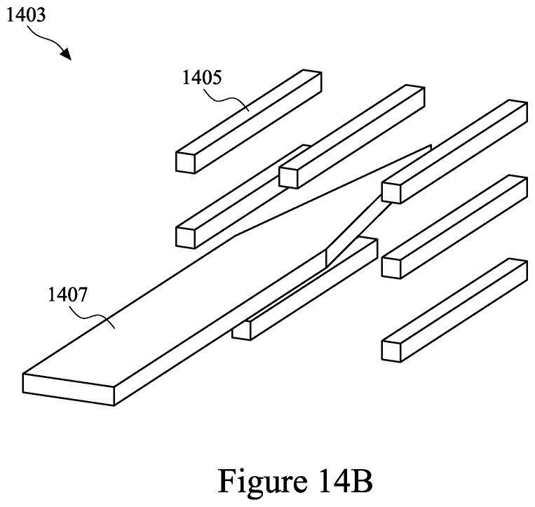

FIG. 14A illustrates another embodiment in which the first optical package 900 is connected to the glass interposer 1001 with third external connectors 1401 instead of dielectric-to-dielectric and metal-to-meal bonds. In this embodiment the third bonding layer 903 is not formed, and, instead, the third external connectors 1401 are used to electrically and physically connect the first optical package 900 to the glass interposer 1001.

The third external connectors 1401 may be conductive bumps (e.g., C4 bumps, ball grid arrays, microbumps, etc.) or conductive pillars utilizing materials such as solder and copper. In an embodiment in which the third external connectors 1401 are contact bumps, the third external connectors 1401 may comprise a material such as tin, or other suitable materials, such as silver, lead-free tin, or copper. In an embodiment in which the third external connectors 1401 are tin solder bumps, the third external connectors 1401 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Once the third external connectors 1401 have been formed, the first optical package 900 may be attached to the glass interposer 1001. In an embodiment the first optical package 900 may be attached to the glass interposer 1001 by aligning the third external connectors 1401 with conductive portions of the glass interposer 1001. Once aligned and in physical contact, the third external connectors 1401 are reflowed by raising the temperature of the third external connectors 1401 past a eutectic point of the third external connectors 1401, thereby shifting the material of the third external connectors 1401 to a liquid phase. Once reflowed, the temperature is reduced in order to shift the material of the third external connectors 1401 back to a solid phase, thereby bonding the first optical package 900 to the glass interposer 1001. Finally, a second underfill 1410 (similar to the first underfill 1110) may be dispensed and cured.

Additionally, in this embodiment the laser die 1103 may be bonded to the glass interposer 1001 adjacent to the first optical package 900 (using, e.g., additional ones of the third external connectors 1401). As such, optical signals 1301 from the laser die 1103 may be transmitted directly to the first optical package 900 without being transmitted through the sixth optical components 1013 of the glass interposer 1001.

In a particular embodiment the fourth optical components 803 of the first optical package 900 and the laser die 1103 may comprise one or more edge couplers 1403 (not individually illustrated in FIG. 14A for clarity), such as a multi-core edge coupler illustrated in FIG. 14B (with surrounding layers removed for clarity) in order to transmit optical signals between the first optical package 900 and the laser die 1103. In the embodiment in which the one or more edge couplers 1403 is a multi-core edge coupler, the one or more edge couplers 1403 may comprise a plurality of cores 1405 located around a tapered portion 1407, wherein the tapered portion 1407 is formed continuously with a waveguide portion (not separately illustrated) of the fourth optical components 803. In this figure the surrounding structures, such as cladding material and the like which are also utilized for support, have been removed in order to more easily illustrate the structure of this embodiment of the one or more edge couplers 1403.

In an embodiment the plurality of cores 1405 is formed in a similar fashion and using similar materials as the other components of the fourth optical components 803, such as the optical waveguides (e.g., depositing a core material such as silicon nitride, patterning the core material, and depositing a cladding material over the core material). Further, in this embodiment there are eight cores 1405 array in three levels. The first level may have three cores 1405 aligned with each other, the second level may have two cores 1405 aligned with each other, and the third level may have three cores 1405 aligned with each other, in a 3-2-3 configuration. Additionally, each of the cores 1405 are aligned with other cores located in a same column. However, any suitable numbers of cores 1405 and any suitable number of levels may be utilized.

Returning to FIG. 14A, the laser die 1103 may transmit the optical signals 1301 to the one or more edge couplers 1403 with additional edge couplers 1403. In an embodiment the edge couplers 1403 located within the laser die 1103 may be similar to the one or more edge couplers 1403 located within the first optical package 900 (e.g., a multi-core edge coupler), wherein edge couplers 1403 within the laser die 1103 are aligned with edge couplers 1403 located within the first optical package 900. However, any suitable transmission structure may be utilized.

FIG. 14A additionally illustrates that, in this embodiment, the first lens 1011 within the glass interposer 1001 may be formed along with a second lens 1409 in order to provide additional paths through the glass interposer 1001 for optical signals 1301. In an embodiment the second lens 1409 may be formed in a similar fashion as the first lens 1011. However, in other embodiments the second lens 1409 may be formed using different processes as the first lens 1011.

Additionally in this embodiment, a coupling module 1413 may be connected to a backside of the glass interposer 1001 in order to provide an additional path of light channeling components. In an embodiment the coupling module 1413 may comprise a substrate 1415 along with eighth optical components 1417 and a fourth mirror 1419. In an embodiment the eighth optical components 1417 and the fourth mirror 1419 may be formed using similar processes and materials as the sixth optical components 1013 and the second mirror 1015 (described above with respect to FIG. 10). However, any suitable processes and materials may be utilized.

Once the coupling module 1413 is prepared, the coupling module 1413 may be bonded to the glass interposer 1001 and a third underfill 1420 (similar to the first underfill 1110) may be dispensed around the coupling module 1413. In an embodiment the coupling module 1413 may be bonded to the glass interposer 1001 using a dielectric-to-dielectric bond (otherwise known as a fusion bond). In particular, the surface of the coupling module 1413 may be activated, the fourth mirror 1419 may be aligned to receive optical signals 1301 from the second lens 1409, and the coupling module 1413 may be physically attached to the glass interposer 1001. However, any suitable attachment process may be utilized.

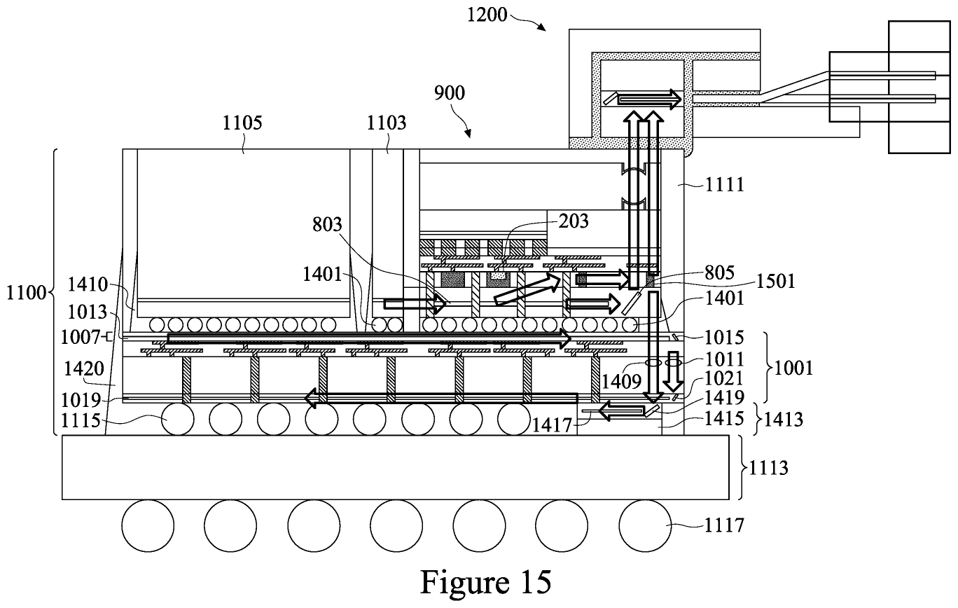

FIG. 15 illustrates that, in the embodiment discussed above with respect to FIGS. 14A-14B, multiple routes through the structure for the optical signals 1301 may be obtained. In a first route, the optical signals 1301 may be generated by the laser die 1103 and are transmitted to the fourth optical components 803 and routed to the first mirror 805. The first mirror 805 redirects the optical signals through the coupling lenses 703 and routed to the fiber array units assembly 1200.

In a second route the optical signals 1301 may be generated by the laser die 1103 and are transmitted to the fourth optical components 803 and then coupled into the first optical components 203, where the optical signals 1301 are routed to a grating coupler 1501 of the first optical components 203. The grating coupler 1501 redirects the optical signals 1301 through the glass interposer 1001 towards the coupling module 1413 through the second lens 1409. The coupling module 1413 may then route the optical signals 1301 as desired, such as back into the seventh optical components 1019 of the fifth bonding layer 1009.

In a third route the optical signals 1301 may be generated by the laser die 1103 and are transmitted to the fourth optical components 803 and then coupled into the first optical components 203, where the optical signals 1301 are routed to the grating coupler 1501 of the first optical components 203. The grating coupler redirects the optical signals 1301 up towards the fiber array unit assembly 1200, where they are received and directed into the optical fibers.

In a fourth route the optical signals 1301 may be generated by the laser die 1103 and are transmitted to the fourth optical components 803 and then coupled into the sixth optical components 1013 of the fourth bonding layer 1007 (or else coupled directly from the laser die 1103 into the sixth optical components 1013 of the fourth bonding layer 1007). The sixth optical components 1013 direct the optical signals 1301 to the second mirror 1015, which redirects the optical signals 1301 through the first lens 1011 to the third mirror 1021. The third mirror 1021 then redirects the optical signals 1301 into the seventh optical components 1019 of the fifth bonding layer 1009.

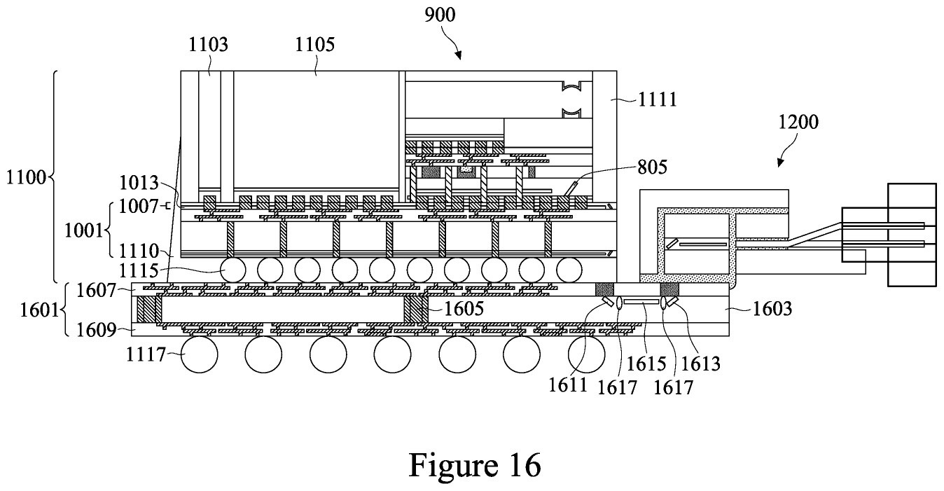

FIG. 16 illustrates yet another embodiment which utilizes the glass interposer 1001. In this embodiment, however, the fiber array unit assembly 1200, instead of being attached to the first optical package 900 (as described above with respect to FIG. 12) is instead attached to a second glass interposer 1601 which takes the place of the second substrate 1113 (described above with respect to FIG. 11). In an embodiment the second glass interposer 1601 comprises a third substrate 1603, second through device vias 1605, a fourth metallization layer 1607, and a fifth metallization layer 1609, along with the second external connectors 1117. In an embodiment the third substrate 1603, the second through device vias 1605, the fourth metallization layer 1607, and the fifth metallization layer 1609 may be formed as described above with respect to the second substrate 1003, the second through device vias 1004, and the third metallization layer 1005. However, any suitable methods and materials may be utilized.

In an embodiment the fiber array unit assembly 1200 may be attached to the second glass interposer 1601 in a similar fashion as described above with respect to the attachment of the fiber array unit assembly 1200. Additionally, in order to accommodate the placement of the fiber array unit assembly 1200, a fifth mirror 1611 and a sixth mirror 1613 are formed with formed within the second glass interposer 1601 in order to receive and transmit the optical signals 1301 from and to the glass interposer 1001. In an embodiment the fifth mirror 1611 and the sixth mirror 1613 are formed in a similar fashion as the first lens 1011, such as using a laser ablation process to modify the properties of the glass of the third substrate 1603. However, any suitable method may be used.

Additionally, if desired, a first waveguide 1615 and third lenses 1617 may be formed in order to modify the optical signals 1301 as the optical signals 1301 pass through the second glass interposer 1601 between the fifth mirror 1611 and the sixth mirror 1613. In an embodiment the first waveguide 1615 and the third lenses 1617 may be formed using a laser ablation process to form the desired holographic patterns inside of the material of the second glass interposer 1601 (e.g., glass). However, any suitable methods, and any other suitable passive devices may be used.

Of course, while the first waveguide 1615 and the third lenses 1617 is described as being formed using the laser ablation process, these are not the only devices that may be formed using the laser ablation process. For example, other waveguides, other lenses, and other passive optical components could be similarly formed. All such devices and all suitable methods for forming those devices are fully intended to be included within the scope of the embodiments.

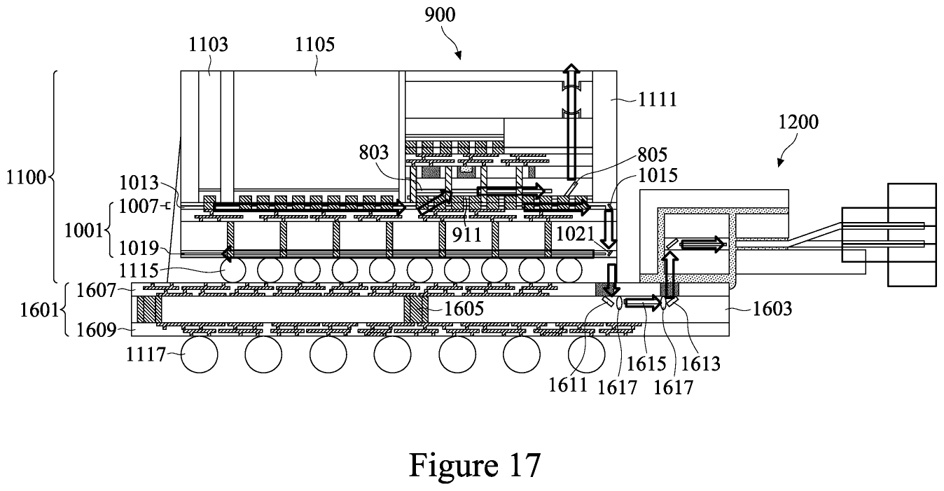

FIG. 17 illustrates that, by utilizing the embodiments described in FIG. 16, even more routes for the optical signals 1301 may be obtained. For example, in a first route for this embodiment, the optical signals 1301 may be created by the laser die 1103 and evanescently coupled to the sixth optical components 1013 within the fourth bonding layer 1007. The fourth bonding layer 1007 routes the optical signals 1301 to the first optical package 900, wherein the optical signals 1301 are evanescently coupled into the fifth optical components 911 of the third bonding layer 903 and the fourth optical components 803 of the second active layer 801. From the fifth optical components 911 and the fourth optical components 803, the optical signals 1301 may be directed towards the first mirror 805, which redirects the optical signals 1301 through the coupling lenses 703 and into exterior couplers (e.g., additional optical fibers not illustrated in FIG. 17).

In a second route for this embodiments, the optical signals 1301 may be created by the laser die 1103 and evanescently coupled to the sixth optical components 1013 within the fourth bonding layer 1007. The fourth bonding layer 1007 routes the optical signals 1301 to the second mirror 1015, which redirects the optical signals 1301 to the third mirror 1021. The third mirror 1021 then redirects the optical signals 1301 into the seventh optical components 1019 of the fifth bonding layer 1009.

In a third route for this embodiment, the optical signals 1301 may be created by the laser die 1103 and evanescently coupled to the sixth optical components 1013 within the fourth bonding layer 1007. The fourth bonding layer 1007 routes the optical signals 1301 to the second mirror 1015, which redirects the optical signals 1301 to the fifth mirror 1611, through the third lenses 1617 and the first waveguide 1615, and to the sixth mirror 1613, which redirects the optical signals 1301 into the fiber array unit assembly 1200.

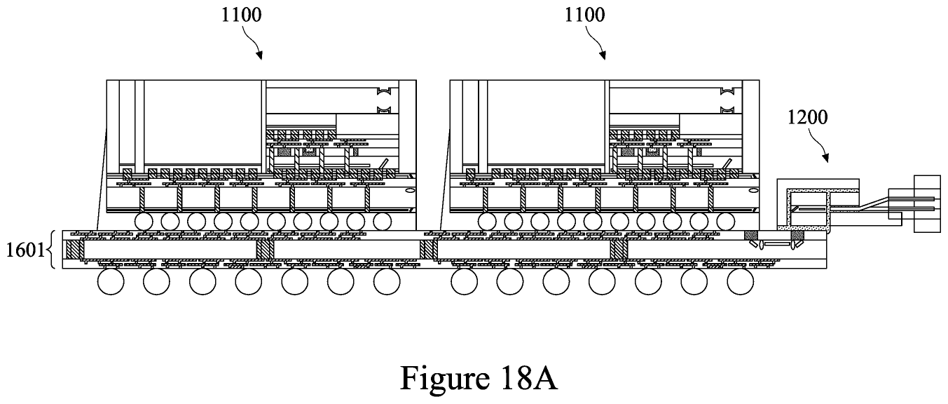

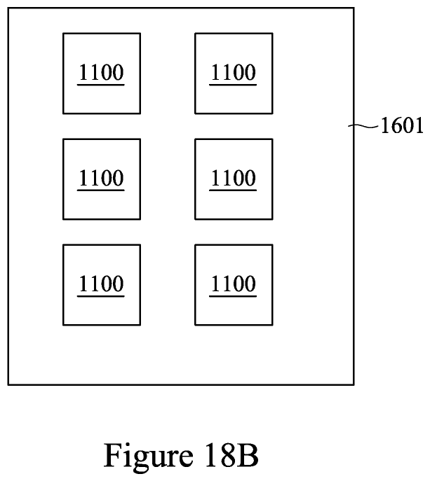

FIG. 18A illustrates another embodiment utilizing the second glass interposer 1601. In this embodiment, however, instead of having a single one of the first modules 1100 connected to the second glass interposer 1601, there are multiples ones of the first modules 1100 connected to the second glass interposer 1601. In an embodiment each of the first modules 1100 may have the same structures (in embodiments in which a similar functionality is desired) or else may have different structures (in embodiments in which different functionalities are desired). Any suitable types of devices may be utilized.

By connecting multiple ones of the first modules 1100 to the second glass interposer 1601, the connection of the fiber array unit assembly 1200 to the second glass interposer 1601 can be used to route optical signals between the fiber array unit assembly 1200 any each of the first modules 1100.

FIG. 18B illustrates a top down view of one possible arrangement of multiple ones of the first modules 1100 on the second glass interposer 1601. As can be seen in this figure, in some embodiments there may be six first modules 1100 arranged in a rectangular pattern on the second glass interposer 1601. However, any suitable number of first modules 1100 arranged in any suitable pattern may be utilized.

Of course, while specific embodiments have been discussed above with respect to FIGS. 1-18B, these embodiments are intended to be illustrative of the ideas and are not meant to limit the ideas to the precise embodiments presented. Rather, the multitude of ideas presented can be arranged in any suitable combination. As one example of an alternative embodiment, the coupling module 1413 may be incorporated into the structure illustrated in FIG. 12. As another example, the embodiments illustrated and discussed with respect to FIGS. 16-18b may also be implemented with the third external connectors 1401 instead of a dielectric-to-dielectric and metal-to-metal bond. Any suitable combination of the ideas may be utilized, and all such combinations are fully intended to be included within the scope of the embodiments.

By utilizing the glass interposers as described above, there is an increase in the dimensional stability of the overall device under thermal load. In particular, by using materials with a similar coefficient of thermal expansion as the other structures (e.g., glass), there is less overall stress related when under a thermal load. Additionally, the visual transparency of glass has alignment benefits, which helps to discern the via hole positions more easily, allowing for a narrower pad layout (whereas previous mis-alignments used a wider pad layout). This allows for a dense juxtaposition of devices and an overall reduction is size, allowing for more devices and a higher overall transmission.

In an embodiment, a method of manufacturing an optical device includes: forming a first optical package; and bonding the first optical package to a first glass interposer. In an embodiment the method further includes bonding a laser die to the first glass interposer. In an embodiment the first optical package comprises a multi-core edge coupler aligned with an output of the laser die. In an embodiment the laser die is optically coupled to the first optical package through the first glass interposer. In an embodiment the method further includes bonding the first glass interposer to a second glass interposer. In an embodiment the method further includes attaching a fiber array unit to the second glass interposer. In an embodiment the method further includes attaching a fiber array unit to the second glass interposer.

In another embodiment, a method of manufacturing an optical device includes: forming through vias through a glass material of an interposer; forming a first redistribution layer over the glass material, the first redistribution layer comprising conductive components and optical components; bonding a first optical device onto the first redistribution layer; and bonding a laser die to the first redistribution layer. In an embodiment the bonding the first optical device comprises a dielectric-to-dielectric and metal-to-metal bonding process. In an embodiment the bonding the first optical device comprises reflowing a conductive bump. In an embodiment the method further includes forming a first lens in the glass material using at least in part a laser ablation process. In an embodiment the method further includes forming a second redistribution layer on an opposite side of the glass material from the first redistribution layer, the second redistribution layer including: second optical components; and a first mirror, wherein a second mirror is located within the first redistribution layer. In an embodiment the method further includes connecting a fiber array unit to the first optical device. In an embodiment the method further includes: bonding a second interposer to the interposer, the second interposer comprising through vias extending through a second glass material; and connecting a fiber array unit to the second interposer.

In yet another embodiment an optical device includes: a first interposer comprising a through via extending through a first glass material; and a first optical device bonded to the first interposer. In an embodiment the first optical device is a first optical package. In an embodiment the optical device further includes a laser die bonded to the first interposer, the laser die optically connected to the first optical device through the first interposer. In an embodiment the optical device further includes a laser die bonded to the first interposer, the laser die optically connected to the first optical device through a multi-core edge coupler located within the first optical device. In an embodiment the optical device further includes a second interposer bonded to the interposer. In an embodiment the optical device further includes a fiber array unit connected to the second interposer, wherein the second interposer comprises a second glass material.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an optical device, the method comprising:
forming a first optical package; and
bonding the first optical package to a first glass interposer.

2. The method of claim 1, further comprising bonding a laser die to the first glass interposer.

3. The method of claim 2, wherein the first optical package comprises a multi-core edge coupler aligned with an output of the laser die.

4. The method of claim 2, wherein the laser die is optically coupled to the first optical package through the first glass interposer.

5. The method of claim 1, further comprising bonding the first glass interposer to a second glass interposer.

6. The method of claim 5, further comprising attaching a fiber array unit to the second glass interposer.

7. The method of claim 1, further comprising attaching a fiber array unit to the second glass interposer.

8. A method of manufacturing an optical device, the method comprising:
forming through vias through a glass material of an interposer;
forming a first redistribution layer over the glass material, the first redistribution layer comprising conductive components and optical components;
bonding a first optical device onto the first redistribution layer; and
bonding a laser die to the first redistribution layer.

9. The method of claim 8, wherein the bonding the first optical device comprises a dielectric-to-dielectric and metal-to-metal bonding process.

10. The method of claim 8, wherein the bonding the first optical device comprises reflowing a conductive bump.

11. The method of claim 8, further comprising forming a first lens in the glass material using at least in part a laser ablation process.

12. The method of claim 11, further comprising forming a second redistribution layer on an opposite side of the glass material from the first redistribution layer, the second redistribution layer comprising:
second optical components; and
a first mirror, wherein a second mirror is located within the first redistribution layer.

13. The method of claim 8, further comprising connecting a fiber array unit to the first optical device.

14. The method of claim 8, further comprising:
bonding a second interposer to the interposer, the second interposer comprising through vias extending through a second glass material; and
connecting a fiber array unit to the second interposer.

15. An optical device comprising:
a first interposer comprising a through via extending through a first glass material; and
a first optical device bonded to the first interposer.

16. The optical device of claim 15, wherein the first optical device is a first optical package.

17. The optical device of claim 15, further comprising a laser die bonded to the first interposer, the laser die optically connected to the first optical device through the first interposer.

18. The optical device of claim 15, further comprising a laser die bonded to the first interposer, the laser die optically connected to the first optical device through a multi-core edge coupler located within the first optical device.

19. The optical device of claim 15, further comprising a second interposer bonded to the interposer.

20. The optical device of claim 19, further comprising a fiber array unit connected to the second interposer, wherein the second interposer comprises a second glass material.
